(19) United States
(12) Patent Application Publication
(10) Pub. No.: US 2010/0141161 A1
(43) Pub. Date: Jun. 10, 2010

(54) HOLIDAY LED LIGHTING SYSTEM AND METHODS OF USE

(75) Inventors: Dean H. Hering, Raleigh, NC (US); Robert J. Dougherty, Herndon, VA (US); John R. Dixon, Herndon, VA (US)

Correspondence Address: MOORE & VAN ALLEN PLLC, P.O. BOX 13706, Research Triangle Park, NC, 27709, US

(73) Assignee: NetCentrics Corporation, Herndon, VA (US)

(21) Appl. No.: 12/398,266

(22) Filed: Mar. 5, 2009

Related U.S. Application Data
(60) Provisional application No. 61/121,230, filed on Dec. 10, 2008.

(51) Int. Cl. F21S 4/00

(52) U.S. Cl. 315/185 S

(57) ABSTRACT

The present disclosure provides a decorative light string system comprising a light string comprising a plurality of lighting bulbs arranged electrically in series, wherein each light bulb comprises at least two LED chips, wherein half of said LED chips are connected in parallel and wherein half of said LED chips are connected in reverse parallel; and a switch box, and a switchbox comprising a switch having at least a first position and a second position, wherein when the switch is in the first position, a first pole is engaged allowing passage of a positive waveform lighting the LEDs connected in parallel, and wherein when the switch is in a second position, a second pole is engaged allowing passage of a negative waveform lighting the LEDs connected in reverse parallel; as well as methods of using said decorative light string system.

### CROSS-REFERENCE TO RELATED APPLICATIONS

This application claims priority to U.S. Provisional Patent Application No. 60/121,230, filed Dec. 10, 2008 in the name of Dean Hering et al. and entitled “Holiday LED Lighting System and Methods of Use,” the contents of which are hereby incorporated by reference.

### FIELD OF THE INVENTION

The present disclosure relates to decorative LED lights, and more particularly, to multicolored LED lights connected in reverse parallel.

### BACKGROUND OF THE INVENTION

Conventional decorative lights are typically fixed in color and celebratory purpose. For example, some conventional light strings comprise a plurality of lights that all have the same color (e.g., all white, all red, etc.). Another conventional light string comprises a plurality of lights that are multicolored (e.g., red, green, blue, yellow, white, etc.). Further, some of these light strings are designed to all be lit at the same time, while others are designed to turn on and off intermittently (e.g., flashing or blinking). Many of these lights are suitably colored for a particular holiday, e.g., Christmas, where the lights may be solid red and green, as well as other holidays where lights are hung as part of the celebratory decoration, including Easter, where pastel colors are popular, the Fourth of July (i.e., Independence Day) and Memorial Day, where the colors red, white and blue are popular, and Halloween, where orange and yellow are popular. For these and other celebrations, such as parties, birthdays, anniversaries and the like, an individual must purchase several different light strings having the appropriate color combination. Typically, the individual will then hang the light strings prior to the occasion and then remove them once the occasion is over. The purchase of numerous light strings can become expensive and the constant placing and removing of the different light strings can be time-consuming.

To address these problems, color-controllable light strings have been designed. However, these products have many limitations. For example, there may be unattractive non-lit bulbs along the light string in at least some selected color schemes or the number of wired lines along the light strand may be relatively large depending on the number of color combinations. Other considerations and/or limitations also include the longevity of the light string, cost of the light string, the limitations of particular/unpopular colors, etc. Accordingly, there remains a need for a color-controllable light string that addresses these limitations and considerations.

### SUMMARY OF THE DISCLOSURE

The present disclosure addresses these shortcomings by providing a long-lasting, cost-effective color-changeable light string system and methods of use. One aspect of the disclosure provides a decorative light system comprising at least one light string having a first end comprising a plug, a second end having a receptacle to receive a plug, and a plurality of light bulbs dispersed between the first end and the second end, each light bulb arranged electrically in series, and the light bulbs comprising at least two LED chips, wherein at least one LED chip is connected in parallel and at least one LED chip is connected in reverse parallel; and a switchbox comprising at least one outlet to receive the plug of the light string, a power cord for connecting to a power means, and a switch having at least a first position and a second position, wherein when the switch is in the first position, a first pole is engaged allowing passage of a positive waveform lighting the LEDs connected in parallel and wherein when the switch is in the second position, a second pole is engaged allowing passage of a negative waveform lighting the LEDs connected in reverse parallel.

Another aspect of the present disclosure provides a decorative light system comprising a light string comprising a first end having a plug, a second end having a receptacle to receive a plug, a plurality of light bulbs dispersed between the first end and the second end, each light bulb arranged electrically in series, the light bulbs comprising at least two LED chips, wherein at least one LED chip is connected in parallel and at least one LED chip is connected in reverse parallel; and a switchbox integrated into the light string, the switchbox comprising a switch having a first position and a second position, wherein when the switch is in the first position, a first pole is engaged allowing passage of a positive waveform lighting the LEDs connected in parallel and wherein when the switch is in the second position, a second pole is engaged allowing passage of a negative waveform lighting said LEDS connected in reverse parallel.

Another aspect of the present disclosure provides a light string comprising a first end having a plug, a second end having a receptacle to receive a plug, at least one current limiting resistor serially connected to the light string, a plurality of light bulbs dispersed between the first end and the second end, each light bulb arranged electrically in series, the light bulbs comprising at least two LED chips each having a different color, wherein at least one LED chip is connected in parallel and at least one LED chip is connected in reverse parallel; and a switchbox comprising a switch having a first position, a second position, and a third position, wherein when the switch is in the first position, a first pole is engaged allowing passage of a positive waveform lighting the LEDs connected in parallel, wherein when the switch is in the second position, a second pole is engaged allowing passage of a negative waveform lighting the LEDs connected in reverse parallel, and wherein when the switch is in the third position, a third pole is engaged allowing passage of both a positive and negative waveform lighting the LEDs connected in parallel in a first color and the LEDs in reverse parallel in a second color.

In certain embodiments, the light system comprises a plurality of light strings electrically connected in series.

In other embodiments, the light system further comprises at least one current limiting resistor serially connected to the light string.

In yet another embodiment, the bulb comprises at least two LED chips, each having a different color.

In certain embodiments, the switchbox further comprises a third position, wherein when the switch is in the third position, a third pole is engaged allowing passage of both a positive and negative waveform lighting the LEDs connected in parallel in a first color and the LEDs connected in reverse parallel in a second color.

In another embodiment, the switchbox further comprises a fourth position, wherein when the switch is in the fourth position a fourth pole is engaged preventing the waveforms from passing through the light string.

In other embodiments, the switch is controlled by a remote control.

Other aspects of the present disclosure provide methods of changing the color of light emitted from a bulb on a light string of the present disclosure. In one embodiment, the method comprises connecting a power cord to a power means, connecting a plug of the light string into the outlet of the switchbox, manipulating the switch to the first position, wherein when the switch is in the first position, a first pole is engaged allowing passage of a positive waveform that is passed through the light string lighting half of the LEDs connected in parallel in a first color and optionally manipulating the switch to the second position, the second pole is engaged allowing passage of a positive waveform that is passed through the light string thereby lighting half of the LEDs connected in reverse parallel in a second color.

In another embodiment, the present disclosure provides a method of changing the color of light emitted from a bulb on a light string comprising connecting the plug to a power means, manipulating the switch to the first position, wherein when the switch is in the first position, a first pole is engaged allowing passage of a positive waveform that is passed through the light string lighting half of said LEDs connected in parallel in a first color; and optionally manipulating the switch to the second position, wherein when the switch is in the second position, a second pole is engaged allowing passage of a negative waveform that is passed through the light string thereby lighting half of the LEDs connected in reverse parallel in a second color.

In other embodiments, the methods of the present disclosure further comprise optionally manipulating the switch to the third position, wherein when the switch is in the third position, a third pole is engaged allowing passage of both a positive and negative waveform lighting the LEDs connected in parallel in a first color and the LEDs connected in reverse parallel in a second color.

In yet other embodiments, the methods further comprise optionally manipulating the switch to a fourth position, wherein when the switch is in the fourth position, a fourth pole is engaged preventing the waveform from passing through the light string.

These and other novel features and advantages of the disclosure will be fully understood from the following detailed description and the accompanying drawings.

### FIGURES AND DRAWINGS

FIG. 1 is a schematic depiction of a light string system according to one embodiment of the present disclosure.

FIG. 2A is a depiction of a light string system according to the present disclosure. FIG. 2B is another embodiment of a light string system according to one embodiment of the present disclosure. FIG. 2C is another embodiment of a light string system according to one embodiment of the present disclosure.

FIG. 3A is a schematic view depicting the typical AC voltage waveform in a standard household outlet of 60 Hz/120V. FIG. 3B is a schematic view depicting the positive half-period of Sin AC waveform when a pole is connected. FIG. 3C is a schematic view depicting the negative half-period of Sin AC waveform when the pole is reversed.

FIG. 4A is a schematic view depicting a light string system according to an embodiment of the present disclosure where the switch is in a first position allowing the positive half-period of the Sin AC waveform to light the LEDs in parallel in a first color. FIG. 4B is a schematic view depicting a light string system according to an embodiment of the present disclosure where the switch is in a second position allowing the negative half-period of the Sin AC waveform to the light the LEDs in the parallel reverse direction in a second color. FIG. 4C is a schematic view depicting a light string system according to an embodiment of the present disclosure where the switch is in a third position allowing both the positive and negative half-periods of the Sin AC waveform to light the LEDs in both the parallel and reverse parallel direction in both a first and second color. FIG. 4D is a schematic view depicting a light string system according to an embodiment of the present disclosure where the switch is in a fourth position preventing the passage of any current through the system, thus not allowing any of the LEDs to be lit. FIG. 4E is a schematic view depicting a light string system according to an embodiment of the present disclosure where the switchbox is controlled by a remote control. FIG. 4F is a schematic view depicting a light string according to another embodiment of the present disclosure where the switchbox that is controlled by a remote control.

FIG. 5A is a depiction of an LED light string according to the present disclosure that is set to emit white light when plugged into a switch box. FIG. 5B is a close-up representation the LED light string shown in FIG. 5A. In both FIGS. 5A and 5B, the light units are emitting white light.

FIG. 6A is a depiction of an LED light string according to the present disclosure that is set to emit colored light when plugged into a switch box. FIG. 6B is a close-up representation the LED light string shown in FIG. 6A. In both FIGS. 6A and 6B, the light units are emitting either blue, red, green or orange light.

FIG. 7 is a depiction of the LED light string shown in FIGS. 5A, 5B, 6A and 6B when plugged directly into a standard wall outlet without a switchbox (or having the switchbox set to a third position allowing for the passage for both positive and negative waveforms). Both LED chips are illuminated at the same time resulting in the generation of “pastel lights” (i.e., the mixture of white light and either blue, red, green or orange light).

### DESCRIPTION OF EMBODIMENTS

Unless otherwise defined, all technical terms used herein have the same meaning as commonly understood by one of ordinary skill in the art to which this disclosure belongs.

The articles “a” and “an” are used herein to refer to one or to more than one (i.e. at least one) of the grammatical object of the article. By way of example, “an element” means at least one element and can include more than one element.

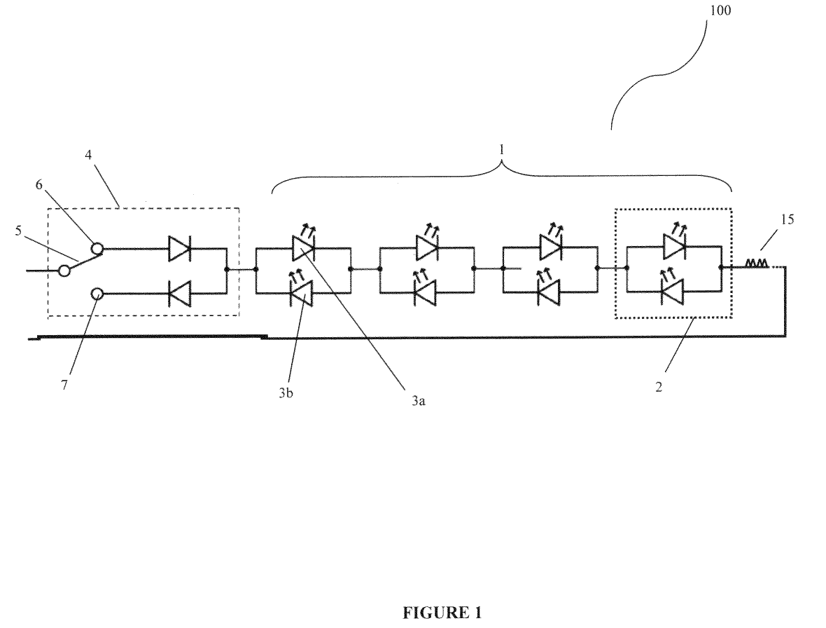

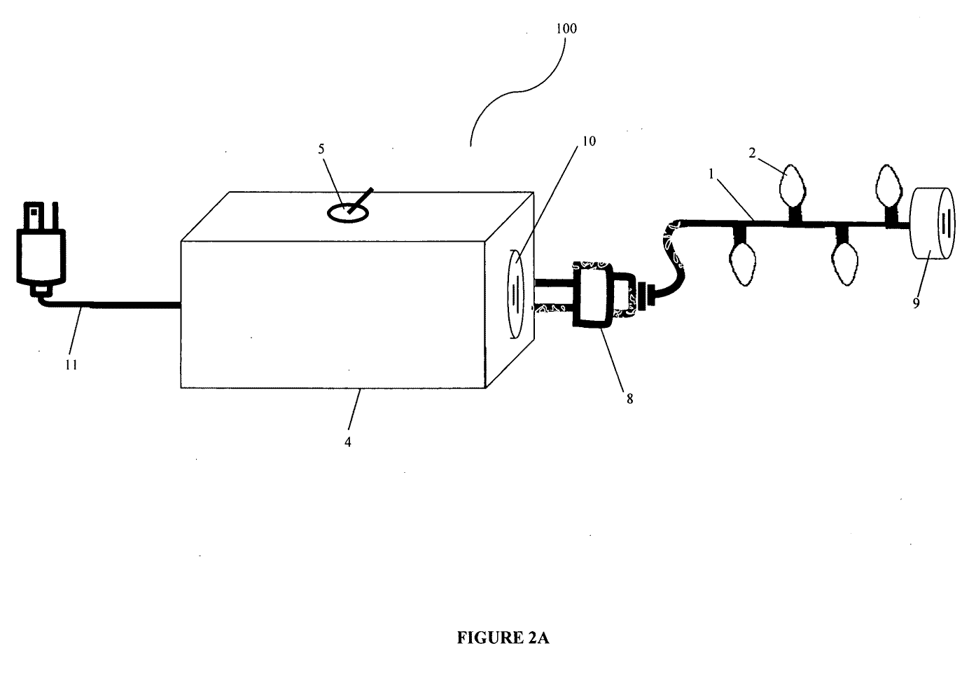

As shown in FIG. 1, one aspect of the present disclosure generally provides a light string system 100 comprising a light string 1 comprising a plurality of light bulbs 2 arranged electrically in series, wherein the light bulbs comprise at least two LED chips 3a and 3b, wherein at least one LED chip is connected in parallel 3a and at least one LED chip is connected in reverse parallel 3b, and a switchbox 4 comprising a switch 5 having at least a first position and a second position, wherein when the switch is in the first position, a first pole 6 is engaged allowing passage of a positive waveform lighting the LEDs connected in parallel 3a, and wherein when the switch is in a second position, a second pole 7 is engaged allowing passage of a negative waveform lighting the LEDs connected in reverse parallel 3b. In certain embodiments, the system further comprises at least one current limiting resistor 15 that is serially connected to the light string for limiting current.

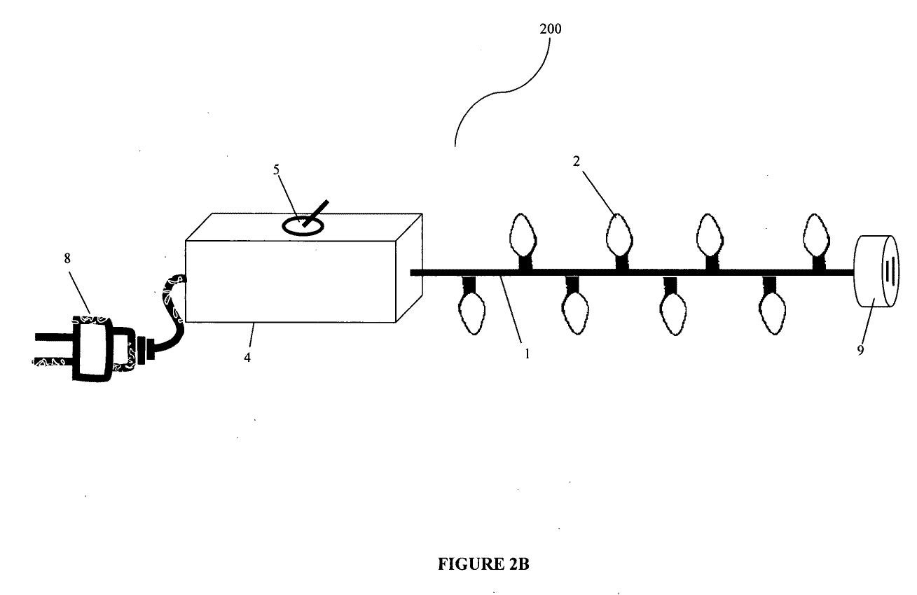

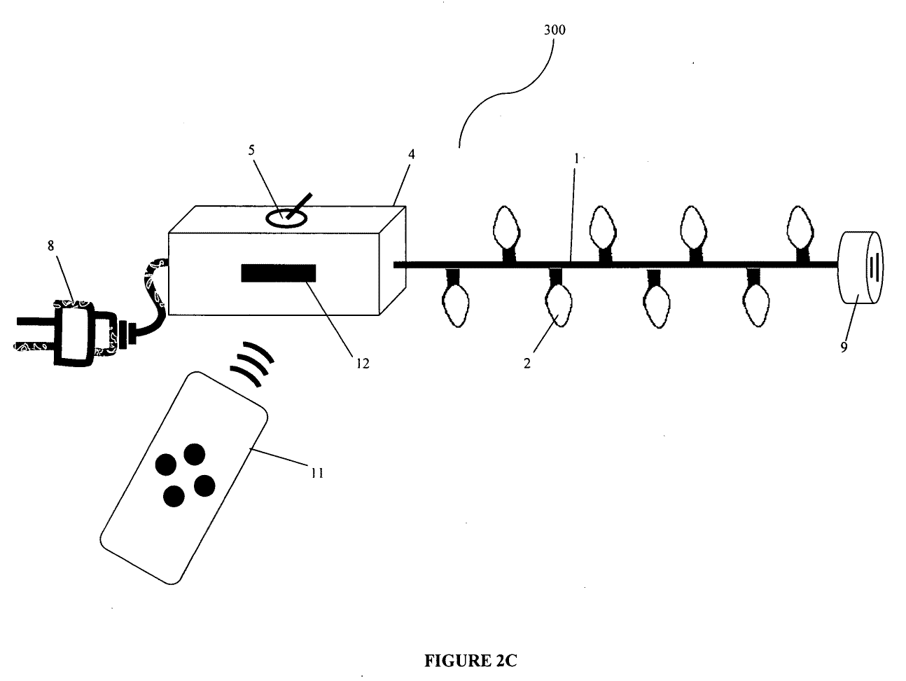

The light string system of the present disclosure may comprise many variations, all of which are within the scope of the present disclosure. For example, in one embodiment, and as shown in FIG. 2A, the decorative light system 100 comprises at least one light string 1 having a first end comprising a plug 8, a second end having a receptacle to receive a plug 9, and a plurality of light bulbs 2 dispersed between the first end and the second end, each light bulb arranged electrically in series, and the light bulbs comprising at least two LED chips, wherein at least one LED chip is connected in parallel and at least one LED chip is connected in reverse parallel; and a switchbox 4 comprising at least one outlet 10 to receive the plug 8 of a light string 1, a power cord 11 for connecting to a power means, and a switch 5.

In another embodiment of the present disclosure, and as shown in FIG. 2B, the light string system 200 comprise a switchbox 4 that is integrated into the light string 1. In such embodiments, the light string 1 comprises a first end having a plug 8, a second end comprising a receptacle for receiving a plug 9, a plurality of light bulbs 2 dispersed between the first and second end, and a switchbox 4 serially connected to the light string 1. The switchbox 4 may be positioned anywhere along the light string. In preferred embodiments, the switchbox 4 is positioned towards the first end having a plug 8 of the light string 1.

In another embodiment of the present disclosure, and as shown in FIG. 2C, the light string system 300 may be operable by a remote control 11. In such embodiments, the light string system further comprises a remote control 11 and the switchbox 4 further comprises a detecting means 12.

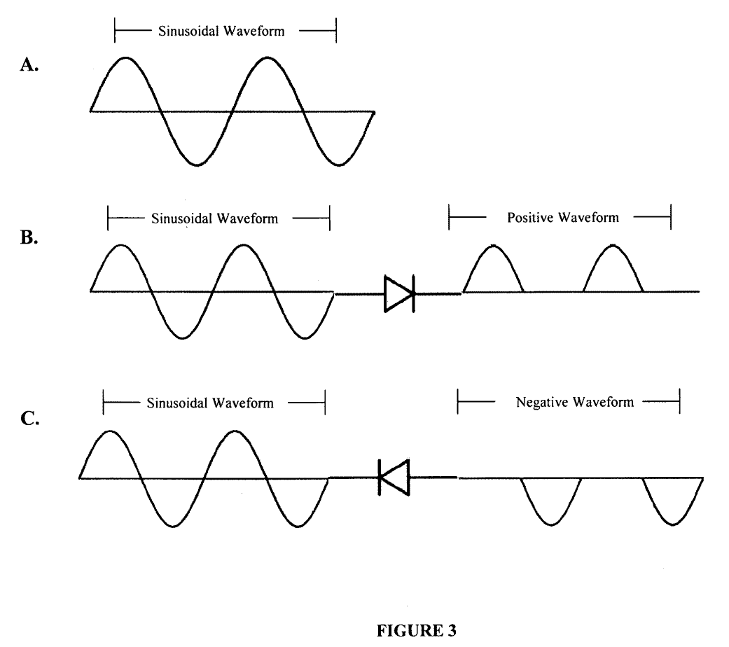

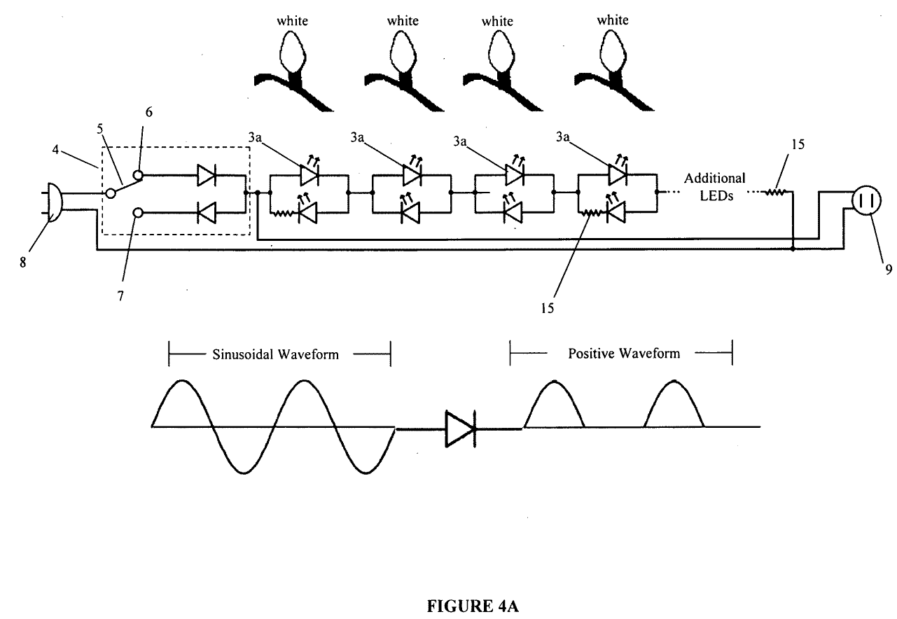

The total operational voltage of the light string 1 of the present disclosure that is connected in series is equal to AC voltage in commercial power since each unit is connected in series, and thus does not require the need for a step-down transformer. For example, the average power supply to a household is 120V and follows a typical sinusoidal waveform as shown in FIG. 3A. A string of lights having approximately 40 bulbs can in turn be connected in series if the operational voltage of the LED is 3V. In accordance with the present disclosure, half of the LEDs are connected in parallel, and therefore the positive half-period of Sin AC waveform (see FIG. 3B) will cause the lighting of all LEDs that are connected in forward (parallel) direction. Similarly, all of the LEDs connected in the reverse (reverse parallel) direction thereof will light during the negative half-period of Sin AC waveform (see FIG. 3C).

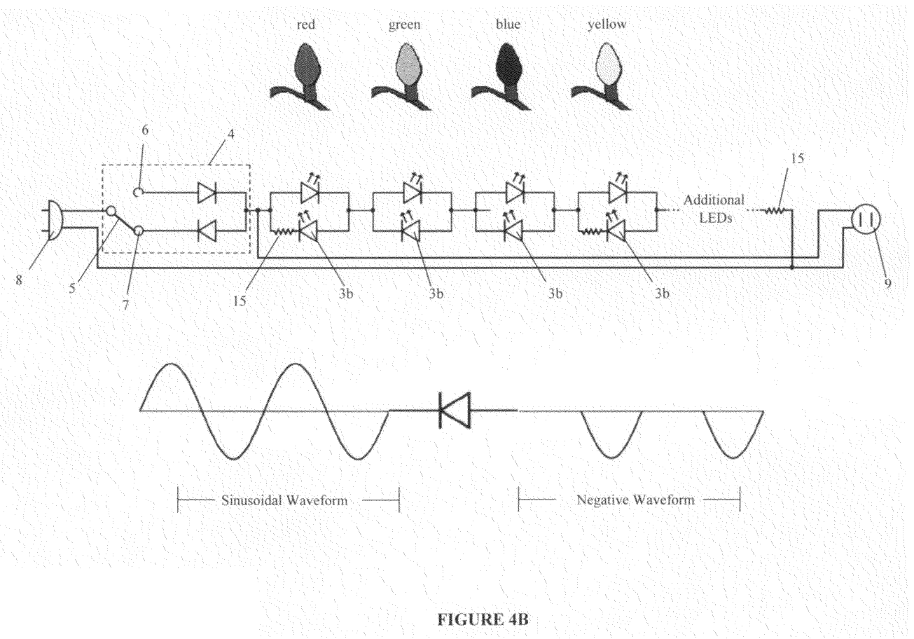

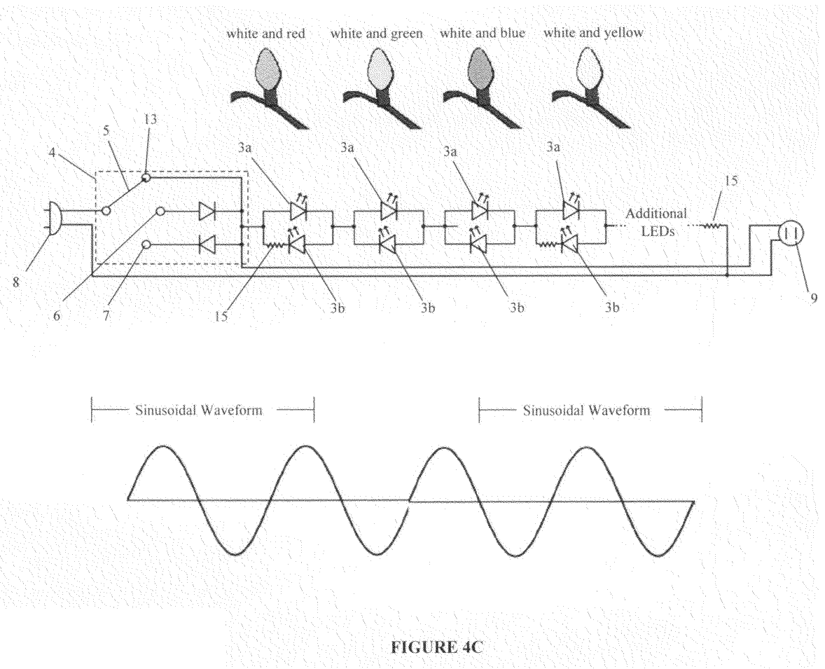

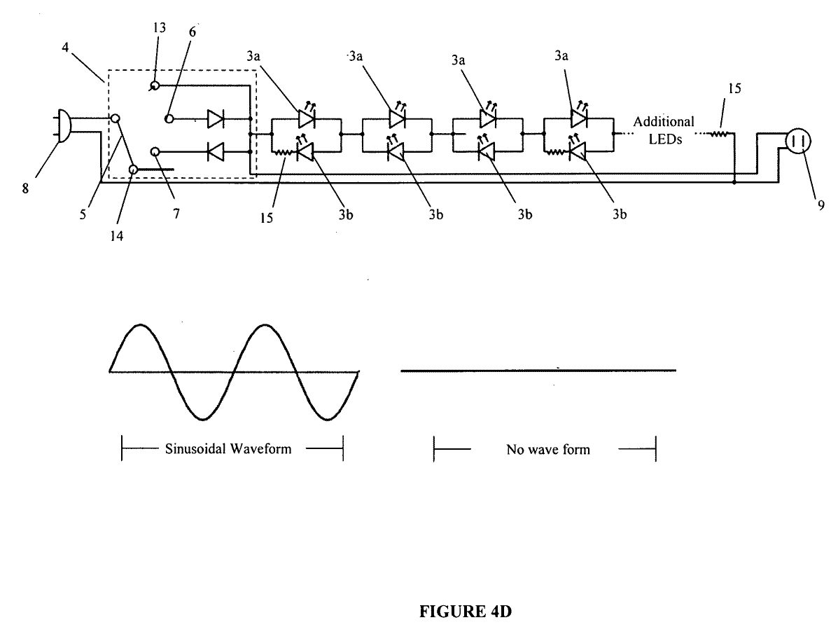

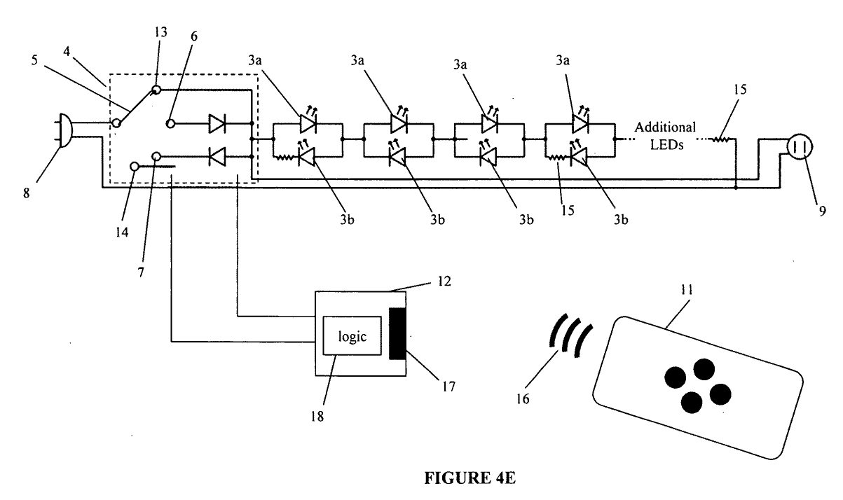

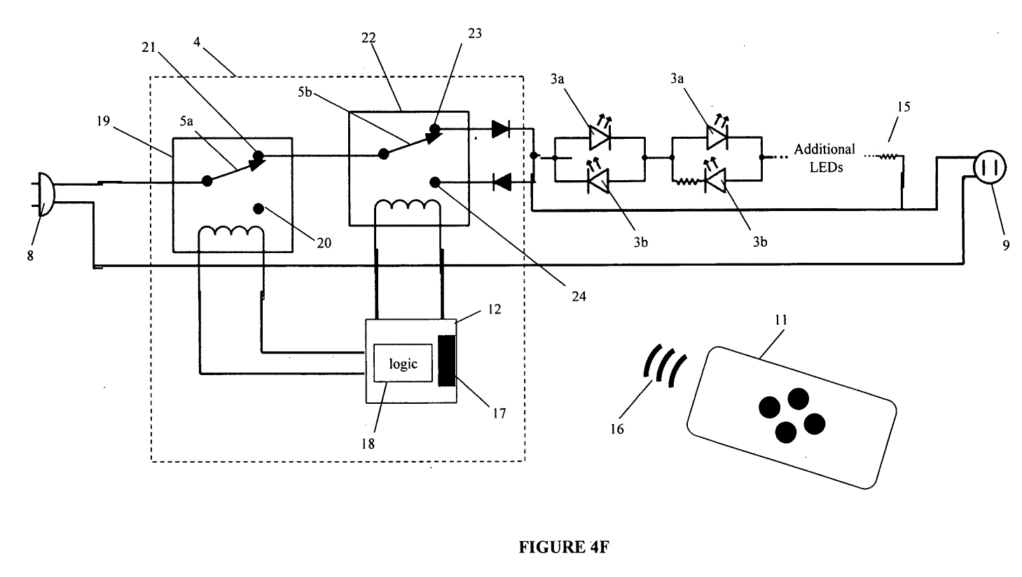

Referring to FIGS. 4A-4D, the switchbox 4 of the present disclosure comprises a switch 5 having at least two positions. In one embodiment, and as shown in FIG. 4A, the switchbox 4 comprises a switch 5 having a first position and a second position. When the switch 5 is in the first position, a first pole 6 is engaged allowing for the passage of a positive waveform lighting the LEDs connected in parallel 3a in a first color (e.g., white) As shown in FIG. 4B, when the switch 5 is in the second position, a second pole 7 is engaged allowing for the passage of a negative waveform, thus lighting the LEDs connected in reverse parallel 3b in a second color (e.g., red, green, blue, yellow, etc.). In another embodiment, and as shown in FIG. 4C, the switchbox 4 comprises a switch 5 having a first position, a second position, and a third position. When the switch is in the first position, a first pole 6 is engaged allowing for the passage of a positive waveform lighting the LEDs connected in parallel 3a in a first color. When the switch is in the second position, a second pole 7 is engaged allowing for the passage of a negative waveform thus lighting the LEDs connected in reverse parallel 3b in a second color. When the switch is in the third position, a third pole 13 is engaged allowing for the passage of both positive and negative waveforms, thus lighting the LEDs connected in parallel 3a in a first color and the LEDs connected in reverse parallel 3b in a second color. This mode is referred to as a “pass-through” mode. In another embodiment, and as shown in FIG. 4D, the switchbox 4 comprises a switch having a first position, a second position, a third position, and a fourth position. When the switch is in the first position, a first pole 6 is engaged allowing for the passage of a positive waveform lighting the LEDs connected in parallel 3a in a first color. When the switch is in the second position, a second pole 7 is engaged allowing for the passage of a negative waveform lighting the LEDs connected in reverse parallel 3b in a second color. When the switch is in the third position, a third pole 13 is engaged allowing for the passage of both a positive and negative waveform lighting said LEDs connected in parallel 3a in a first color and the LEDs connected in reverse parallel 3b in a second color. When the switch is in the fourth position, a fourth pole 14 is engaged preventing the passage of any current through the light string. It is within the scope of this disclosure that any standard relay mechanism may be used, and such knowledge is well known to those skilled in the art.

In yet another embodiment, and as shown in FIG. 4E, the switchbox 4 may be controlled by a remote control 11, wherein the remote control 11 controls the position of the switch 5. As shown in FIG. 4E, the remote control 11 emits signals 16 that are detected by a detecting means 12. Preferably, the detecting means 12 will further comprise a signal gathering means 17 and a logic means 18 capable of collecting and converting the signals 16 emitted from the remote control 11 into signals recognized by the switchbox 4 thereby providing for the repositioning of the switch 5 to the desired position. The remote control is preferably wireless. In certain embodiments, the remote control 11 works through either infrared signaling or radiofrequency. Examples of suitable infrared and/or radiofrequency detecting means, as well as suitable relay systems, are well known and can be readily identified and manufactured by those skilled in the art without undue experimentation. It is also within the scope of the present disclosure that any combinations of positions may be used.

In another embodiment the switchbox 4 comprises a relay system which comprises two relays 19, 22 controlled by a remote control 11. As shown in FIG. 4F, the first relay 19 comprises a switch 5a having at least a first and a second position. Upon signaling by the remote control 11 positioning the switch 5a in a first position, a first pole 20 is engaged preventing passage of any current through the light string. Alternatively, when the switch 5aengages a second pole 21, current is allowed to pass through to a second relay 22 that comprises a switch 5b having at least two positions that is also controlled by the remote control 11. When the switch 5b of the second relay is in the first position, a first pole 23 is engaged allowing for the passage of a positive waveform lighting the LEDs connected in parallel 3a in a first color. When the switch is in the second position, a second pole 24 is engaged allowing for the passage of a negative waveform thus lighting the LEDs connected in reverse parallel 3b in a second color.

In a preferred embodiment of the present disclosure, the at least two LED chips are within a single bulb or housing. In such embodiments, the two LED chips can be adopted, connected in parallel, connected in reverse parallel, and integrated into a same housing. In this particular scenario, the connection thereof is very convenient and the connection wire can be saved. In one embodiment, the two LED chips comprised in the single housing have two kinds of colors that can be emitted when the two LEDs emit light individually and respectively. Moreover, another one or more colors of light may be achieved by adjusting the overlap time or the sequence of the two LEDs which emit light at the same time. For example, in one embodiment, directly plugging in the light string of the present disclosure into a standard wall socket will result in both LEDs emitting light at the same time, thereby providing additional colors and hues (e.g., pastel colors resulting from the mixing of white light generated from one LED chip and a colored light, such as blue, from the second LED chip). In other embodiments, the switchbox includes a switch position which provides for passage of both positive and negative waveforms down the light string resulting in both LEDs emitting light at the same time (e.g., a pass-through position). Alternatively, the timing of the lighting of both LEDs may be altered to adjust the color as desired. As used herein, the terms “housing” or “bulb” refer to any transparent or translucent material that allows at least some light to pass through, such as glass or plastic.

In other embodiments, each bulb may have more LEDs connected, preferably in even number sets. For example, a bulb may comprise 4, 6, 8 or 10 LED chips, where half of the LED chips are connected in parallel and the other half of the LED chips are connected in reverse parallel. For example, for a bulb comprising 4 LED chips, 2 LED chips may be connected in parallel, and the other two chips may be connected in reverse parallel. In certain embodiments, each LED chip will emit a different color. In other embodiments, all of the LED chips connected in parallel will emit one color, e.g., blue, red, green, yellow, white, etc., while the other LED chips connected in reverse parallel will emit a second color that is different from those connected in parallel. In a preferred embodiment, each bulb comprises 2 LED chips, one that is connected in parallel and the other that is connected in reverse parallel. More preferably, each chip is programmed to emit a color different from the other. It is also within the scope of the present disclosure that any combination of colors may be used. Furthermore, the number of bulbs on each light string can be adjusted accordingly, and can be readily determined by those skilled in the art. In certain embodiments, a light string will comprise between 10 and 200 bulbs electrically connected in series. In other embodiment, the light string will comprise between 10 and 150 bulbs electrically connected in series. In yet other embodiments, the light string will comprise between 10 and 100 bulbs electrically connected in series.

In other embodiments, a plurality of light strings may be serially linked together. In one embodiment, at least two light strings are serially linked together. In another embodiment, at least three light strings are serially linked together. In yet another embodiment, at least four light strings are serially linked together. In embodiments having light strings comprising a switchbox with a pass-through mode, all serially attached strings, except for the very first in the series, will be set to pass-through mode. In such embodiments, it is the switchbox connected to the very first string in the series which will control the passage of negative, positive or both types of waveforms.

In a preferred embodiment, and as shown in FIGS. 4A-4F, the system further comprises a current limiting resistor 15 that is serially connected to the light string for limiting current. The system may also comprise a plurality of light strings connected serially together. Moreover, the system may also comprise a switchbox having at least one additional outlet, whereby each outlet comprises a plurality of light strings connected thereto.

According to another aspect, the present disclosure provides a method of changing colors on a light string according to the present disclosure by connecting the power cord to a power means, connecting the plug of the light string into the outlet of the switchbox, manipulating the switch to a first position, wherein when the switch is in the first position, a first pole is engaged allowing passage of a positive waveform that is passed through the light string lighting half of the LEDs connected in parallel in a first color. For example, as shown in FIGS. 5A and 5B, the lighting of the half of LEDs connected in parallel may result in the generation of white light.

In another embodiment, the present disclosure provides a method changing the color of light emitted from a bulb on the light string comprising connecting the plug to a power means, manipulating the switch to a first position, wherein when the switch is in the first position a first pole is engaged allowing passage of a positive waveform through the light string lighting half of the LEDs connected in parallel in a first color. In preferred embodiments, the switch is integrated into said light string.

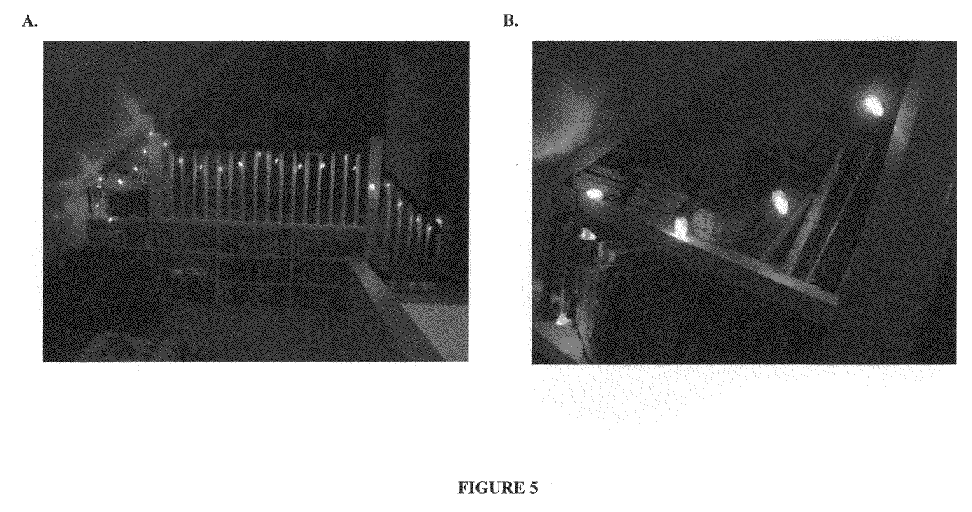

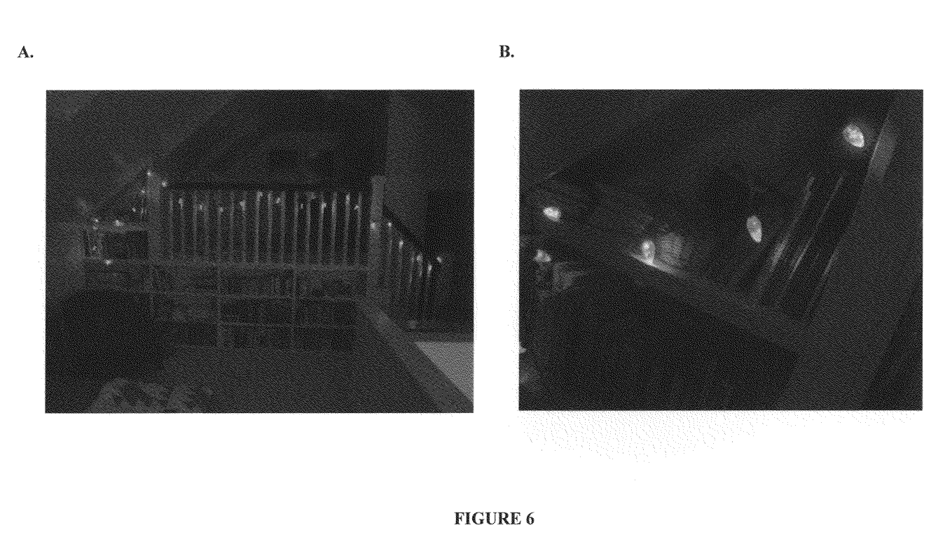

The methods of the present disclosure further provide optionally manipulating the switch to a second position, wherein a second pole is engaged allowing passage of a negative waveform through the light string thus lighting half of the LEDs connected in reverse parallel in a second color. For example, and as shown in FIGS. 6A and 6B, the lighting of the half of LEDs connected in reverse parallel may result in the generation of multi-colored lights (green, blue, red, and orange).

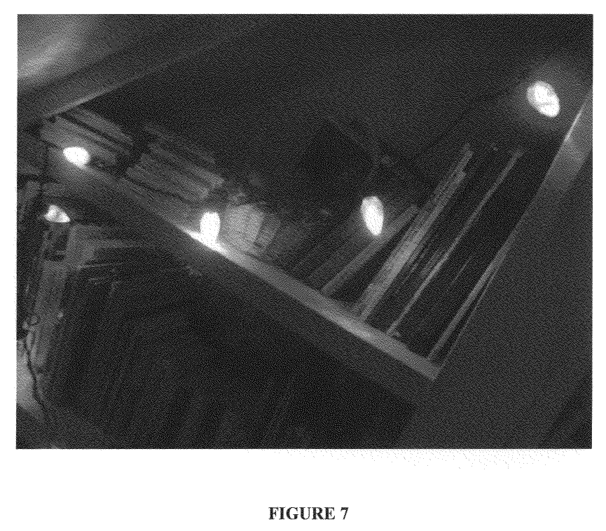

In other embodiments, the methods further provide optionally manipulating the switch to a third position, wherein when the switch is in a third position, a third pole is engaged allowing passage of both positive and negative waveforms lighting the LEDs connected in parallel in a first color and the LEDs connected in reverse parallel in a second color. For example, as shown in FIG. 7, the lighting of both LEDs, where those LEDs in parallel emit white light and those LEDs in reverse parallel emit multicolored lights (green, blue, red and orange) results in the pastel colored light. In another embodiment, plugging the light string of the present disclosure directly into a power source (e.g., a standard wall outlet), will also result in the passage of both positive and negative waveforms resulting in the lighting of LEDs oriented in both parallel and reverse parallel.

In yet another embodiment, the method further provide optionally manipulating the switch to a fourth position, wherein when the switch is in the fourth position a fourth pole is engaged which prevents the passage of both positive and negative waveforms, thereby not lighting any of the LEDs.

It is to be understood that the above is merely a description of preferred embodiments of the disclosure and that various changes, alterations, and variations may be made without departing from the true spirit and scope of the invention as set forth in the appended claims. The several embodiments and variations described above can be combined with each other were suitable. The particular color schemes for the holidays described herein are merely examples and may vary. It is not necessary that the plurality of wires along the decorative light string be intertwined or bound; they could be provided in a 2-dimensional matrix or 3-dimensional structure. Also, the lights in each set need not be interleaved with lights of another set or sets. Few if any of the terms or phrases in the specification and claims has been given any special or particular meaning different from the plain language meaning, and therefore the specification is not to be used to define the terms in an unduly narrow sense.

We claim:

1. A decorative light system comprising:
at least one light string comprising a first end comprising a plug, a second end comprising a receptacle to receive a plug, and a plurality of light bulbs dispersed between said first end and said second end, each light bulb arranged electrically in series, said light bulbs comprising at least two LED chips, wherein at least one LED chip is connected in parallel and at least one LED chip is connected in reverse parallel; and
a switchbox comprising at least one outlet to receive said plug of said light string, a power cord for connecting to a power means, and a switch having at least a first position and a second position, wherein when said switch is in said first position, a first pole is engaged allowing passage of a positive waveform lighting said LEDs connected in parallel and wherein when said switch is in said second position, a second pole is engaged allowing passage of a negative waveform lighting said LEDs connected in reverse parallel.

2. The decorative light system according to claim 1 further comprising a plurality of light strings electrically connected in series.

3. The decorative light system according to claim 1, further comprising at least one current limiting resistor serially connected to said light string.

4. The decorative light system according to claim 1, wherein said bulb comprises at least two LED chips, each having a different color.

5. The decorative light system according to claim 1, wherein said switchbox further comprises a third position, wherein when said switch is in said third position, a third pole is engaged allowing passage of both a positive and negative waveform lighting said LEDs connected in parallel in a first color and said LEDs connected in reverse parallel in a second color.

6. The decorative light system according to claim 5, wherein said switchbox further comprises a fourth position, wherein when said switch is in said fourth position, a fourth pole is engaged preventing said waveforms from passing through said light string.

7. A method of changing the color of light emitted from a bulb on the light string system according to claim 1, said method comprising
a. connecting said power cord to a power means;
b. connecting said plug of said light string into said outlet of said switchbox;
c. manipulating said switch to said first position, wherein when said switch is in said first position, a first pole is engaged allowing passage of a positive waveform that is passed through said light string lighting half of said LEDs connected in parallel in a first color; and
d. optionally manipulating said switch to said second position, said second pole is engaged allowing passage a positive waveform that is passed through said light string thereby lighting half of said LEDs connected in reverse parallel in a second color.

8. A decorative light system comprising:
a light string comprising a first end comprising a plug, a second end comprising a receptacle to receive a plug, a plurality of light bulbs dispersed between said first end and said second end, each light bulb arranged electrically in series, said light bulbs comprising at least two LED chips, wherein at least one LED chip is connected in parallel and at least one LED chip is connected in reverse parallel; and a switchbox integrated into said light string, said switchbox comprising a switch having a first position and a second position, wherein when said switch is in said first position, a first pole is engaged allowing passage of a positive waveform lighting said LEDs connected in parallel and wherein when said switch is in said second position, a second pole is engaged allowing passage of a negative waveform lighting said LEDS connected in reverse parallel.

9. The decorative light system according to claim 8 further comprising a plurality of light strings electrically connected in series.

10. The decorative light system according to claim 8, further comprising at least one current limiting resistor serially connected to said light string.

11. The decorative light system according to claim 8, wherein said bulb comprises at least two LED chips, each having a different color.

12. The decorative light system according to claim 8, wherein said switchbox further comprises a third position, wherein when said switch is in said third position, a third pole is engaged allowing passage of both a positive and negative waveform lighting said LEDs connected in parallel in a first color and LEDs connected in reverse parallel in a second color.

13. The decorative light system according to claim 8, wherein said switchbox further comprises a fourth position, wherein when said switch is in said fourth position, a fourth pole is engaged preventing said waveforms from passing through said light string.

14. The decorative light system according to claim 8, further comprising a remote control, wherein said switch is capable of switching between said first position and said second position by activating said remote control.

15. A method of changing the color of light emitted from a bulb in the light system according to claim 8, said method comprising:
a. connecting said plug to a power means;
b. manipulating said switch to said first position, wherein when said switch is in said first position, a first pole is engaged generating a positive waveform that is passed through said light string lighting half of said LEDs connected in parallel in a first color; and
c. optionally manipulating said switch to said second position, wherein when said switch is in said second position, a second pole is engaged generating a negative waveform that is passed through said light string thereby lighting half of said LEDs connected in reverse parallel in a second color.

16. The method according to claim 15, wherein said manipulation of the switch is done by remote control.

17. A decorative light system comprising:
a light string comprising a first end comprising a plug, a second end comprising a receptacle to receive a plug, at least one current limiting resistor serially connected to said light string, a plurality of light bulbs dispersed between said first end and said second end, each light bulb arranged electrically in series, said light bulbs comprising at least two LED chips each having a different color, wherein at least one LED chip is connected in parallel and at least one LED chip is connected in reverse parallel; and a switchbox comprising a switch having a first position, a second position, and a third position, wherein when said switch is in said first position, a first pole is engaged allowing passage of a positive waveform lighting said LEDs connected in parallel, wherein when said switch is in said second position, a second pole is engaged allowing passage of a negative waveform lighting said LEDs connected in reverse parallel, and wherein when said switch is in said third position, a third pole is engaged allowing passage of both a positive and negative waveform lighting said LEDs connected in parallel in a first color and said LEDs connected in reverse parallel in a second color.

18. The decorative light system according to claim 17 further comprising a plurality of light strings electrically connected in series.

19. The decorative light system according to claim 17, wherein said switchbox further comprises a fourth position, wherein when said switch is in said fourth position, a fourth pole is engaged preventing said waveforms from passing through said light string.

20. The decorative light system according to claim 17, further comprising a remote control, wherein said switch is capable of switching between said first position, said second position, and said third position by activating said remote control.

21. A method of changing the color of light emitted from a bulb in the light system according to claim 17, said method comprising:
a. connecting said plug to a power means;
b. manipulating said switch to said first position, wherein when said switch is in said first position, a first pole is engaged allowing passage of a positive waveform that is passed through said light string lighting half of said LEDs connected in parallel in a first color; and
c. optionally manipulating said switch to said second position, wherein when said switch is in said second position, a second pole is engaged allowing passage of a negative waveform that is passed through said light string thereby lighting half of said LEDs connected in reverse parallel in a second color; and
d. optionally manipulating said switch to said third position, wherein when said switch is in said third position, a third pole is engaged allowing passage of both a positive and negative waveform lighting said LEDs connected in parallel in a first color and said LEDs connected in reverse parallel in a second color.

22. The method according to claim 21, wherein said manipulation of the switch is done by remote control.
